(19) United States
(12) Patent Application Publication
(10) Pub. No.: US 2009/0241055 A1
(43) Pub. Date: Sep. 24, 2009

(54) SYSTEMS AND METHODS FOR SIDE BY SIDE DISPLAY OF DATA MODIFICATION

(76) Inventors: Nancy L. Augustine, Pleasant Hill, CA (US); John Carr, Antioch, CA (US); Ben Goldberg, Pleasanton, CA (US); Randall Jones, Carrollton, TX (US); Cheryl L. Paterson, Alameda, CA (US); Ev Shafrir, Mountain View, CA (US); Gregg Stratton, San Francisco, CA (US)

Correspondence Address: WILSON SONSINI GOODRICH & ROSATI, 650 PAGE MILL ROAD, PALO ALTO, CA, 94304-1050, US

(21) Appl. No.: 12/053,467

(22) Filed: Mar. 21, 2008

(51) Int. Cl. G06F 3/048

(52) U.S. Cl. 715/781

(57) ABSTRACT

Systems and methods for displaying data modification may include a user interface displaying a current data region and a new data region displayed side by side where the new data region may display one or more data interaction interface or data values corresponding to the current data and positioned to mirror the current data position in the current data region. The invention may be applied to payroll processing or human capital management software, which may provide means for displaying human capital management information, such as payroll information, and how it is modified.

### FIELD OF THE INVENTION

This invention is directed to systems and methods of displaying data modification. The invention may be applied to payroll or human capital management software, which may provide means for displaying data modification of payroll or human capital management information of employees.

### BACKGROUND OF THE INVENTION

Every employer is faced with the regular generation of payroll for its employees. Initially, payroll processing was an arduous manual task, requiring the responsible individual to compute the base pay, applicable taxes, and other deductions for each of the employer's employees. Initially, these calculations were performed by hand. Over time, automated systems have been developed to calculate pay, produce payroll checks, and even to make the automatic payroll deposits into an employee's bank account for employees participating in a direct deposit program. Automated systems have also been developed to deal with overall human capital management.

Prior payroll automation and human capital management systems generally provide an employer with the ability to analyze the payroll, to modify payroll data or parameters, or to manage other human capital management data. However, such payroll automation and human capital management systems do not provide a user display of payroll information that may show earlier values of payroll data while providing a means to enter new values of payroll data. Such payroll automation systems fail to provide a comparison for a user between the previous data values and the new data values so the user may be fully informed when modifying or adding new data.

There is a need for improved systems and methods for displaying data modification, especially for data including payroll and human capital management data, in a visually straightforward manner that may indicate change in data.

### SUMMARY OF THE INVENTION

The invention provides systems and methods for displaying data modification in a side by side manner. Various aspects of the invention described herein may be applied to any of the particular applications set forth below or for any other types of user interfaces and displays. The invention may be applied as a standalone system or method, or as part of an integrated software package, such as for payroll or human capital management software. It shall be understood that different aspects of the invention can be appreciated individually, collectively, or in combination with each other.

An aspect of the invention provides for a user interface shown on a display. For example, the implementation of a software may include a client computer comprising a video display, with at least one display page comprising data. The data may include human capital management data, which may include data such as payroll data (including items such as wage compensation and benefits), workforce planning, recruitment, induction/orientation, skills management, training and development, personnel administration, time management, travel management, personnel cost planning, or performance appraisal.

Another aspect of the invention provides for a user interface with a side by side display which may include a current data region and a new data region. A data region may include a region of the user interface display. A current data region may display current data or a current data field and a new data region may display one or more data interaction interface or new data field, which may correspond to the current data and may be positioned in such a way to mirror the position of, or visually map to, the current data in the current data region.

Current data may be data values at a current time. In one embodiment of the invention, current time may be defined as the moment in which a user is viewing the current data region. In another embodiment of the invention, a current time may be defined as a moment chosen by a system or a user.

A data interaction interface may be part of a user interface that may enable a user to modify, create, or otherwise interact with data. Several examples of types of data interaction interfaces may include a field in which a user may type in a value, a drop down menu, a button to choose an option, button to pop up another window, a link, and any other means for a user to interact with data. In one embodiment of the invention, the data interaction interfaces may start with a default value.

In a preferable embodiment of the invention, the user interface may include a side by side display including a current data region where the data may include payroll or human capital management data. The new data region of the side by side display may also display data interaction interfaces which may relate to modifying such payroll or any human capital management data.

The current data region and the new data region may be displayed side by side so that corresponding data may substantially mirror one another. In a preferable embodiment of the invention, being side by side may indicate that the current data region and new data region may be adjacent to each other horizontally, and corresponding data and data interaction interfaces may be displayed vertically within the data regions and may mirror one another.

After a user interacted with the data interaction interfaces, the system may be able to store the new data values. In one embodiment of the invention, interacting with the data interaction interfaces may result in a change in the display of the data interaction interfaces in a new data region.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The features and advantages of the invention may be further explained by reference to the following detailed description and accompanying drawings that sets forth illustrative embodiments.

FIG. 1 shows a system with client computers interacting with a server over a network.

FIG. 2 shows a user interface with a side by side display including a current data region and a new data region.

FIG. 3 shows an embodiment of a side by side display.

FIG. 4 shows an alternate embodiment of a side by side display.

FIG. 5 shows an embodiment of a side by side display, which may allow new information to be added in a new data region.

FIG. 6 shows a user interface where interacting with a new data region may cause the data interaction interfaces of the new data region to change.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

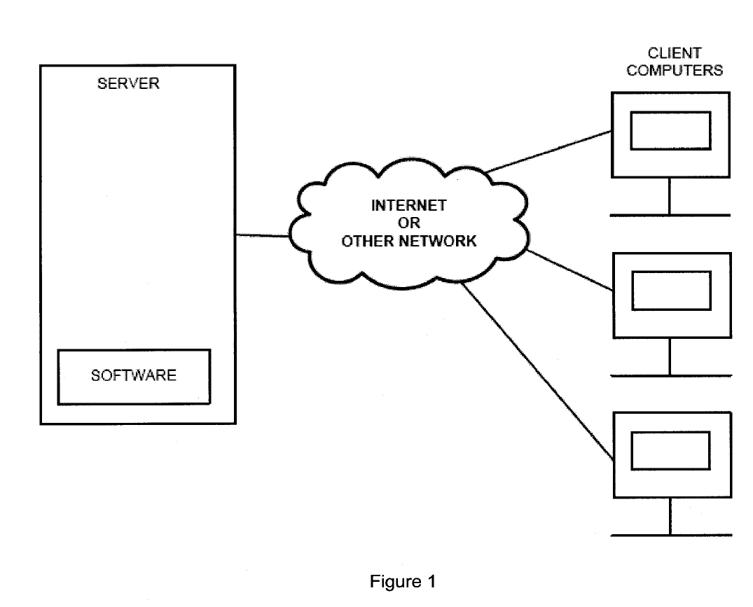

A user interface provided in accordance with the invention herein may be displayed across a network such as the Internet. For example, as shown in FIG. 1, an implementation of may include a client computer comprising a video display with at least one display page comprising data. The data may include human capital management data, which may include data such as payroll data (including items such as wage compensation and benefits), workforce planning, recruitment, induction/orientation, skills management, training and development, personnel administration, time management, travel management, personnel cost planning, or performance appraisal. Human capital management data may include data that can be person and time dependent. Human capital management may be heterogeneous across different businesses and a human capital management outsourcing software may advantageously display human capital management data.

Video displays may include devices upon which information may be displayed in a manner perceptible to a user, such as, for example, a computer monitor, cathode ray tube, liquid crystal display, light emitting diode display, touchpad or touchscreen display, and/or other means known in the art for emitting a visually perceptible output. Video displays may be electronically connected to a client computer according to hardware and software known in the art.

In one implementation of the invention, a display page may include a computer file residing in memory which is transmitted from a server over a network to a client computer, which can store it in memory. Similarly, one or more servers may communicate with one or more client computers across a network, and may transmit computer files residing in memory. The network, for example, can include the Internet or any network for connecting one or more clients to one or more servers.

At the client computer, the display page may be interpreted by software residing on a memory of the client computer, causing the computer file to be displayed on a video display in a manner perceivable by a user. The display pages described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a computer file displayable on a video display in a manner perceivable by a user. Where network comprises the Internet, a display page may comprise a webpage of a type known in the art.

A display page according to the invention may include embedded functions comprising software programs stored on a memory, such as, for example, VBScript routines, JScript routines, JavaScript routines, Java applets, ActiveX components, ASP.NET, AJAX, Flash applets, Silverlight applets, or AIR routines.

A display page may comprise well known features of graphical user interface technology, such as, for example, frames, windows, scroll bars, buttons, icons, and hyperlinks, and well known features such as a “point and click” interface. Pointing to and clicking on a graphical user interface button, icon, or hyperlink also is known as “selecting” the button or hyperlink. A display page according to the invention also may incorporate multimedia features.

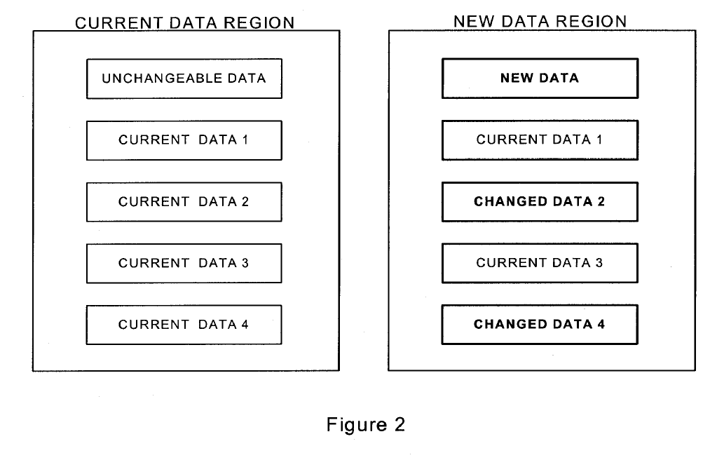

Referring to the drawings in detail, FIG. 2 shows a user interface may include a side by side display which be displayed on a video display. The user interface may include a side by side display including a current data region and a new data region. A data region may include a region of the user interface display. For example, a data region may have a defined geometric shape, such as a rectangle. In another example, a data region may have any defined shape, even if it irregular. A shape may be defined by some sort of visual cue, such as a border or color change. Alternatively, the data region itself may not have a defined shape, but may include a region or area which may display data.

A current data region may display current data or current data field and a new data region may display one or more data interaction interface or new data field, which may correspond to the current data and may be positioned in such a way to mirror, or visually map to, the position of the current data in the current data region. A new data region may also include displayed data values in addition to data interaction interfaces.

Current data may include data values at a current time. A current data region may show pre-existing data values at a current time, which can be defined in a number of ways. In one embodiment of the invention, current time may be defined as the moment in which a user is viewing the current data region. For example, if a user were to view a current data region on a particular date, the current data region may show data values for that date. If a user were to view a current data region on February 2 nd, the current data region may show data values for February 2 nd, regardless of whether the data values are scheduled to change at a later date or not.

In another embodiment of the invention, a current time may be defined as a moment chosen by a system or a user. For example, a user may view a current data region on a particular date, but the current time may be defined as the next pay period, so the current data region may show data values for the next pay period. The system may be set up so that regardless of the date that the user views the side by side display, the current data region will show data values for a next pay period. So if the next pay period is February 15 th, a user may see data values for February 15 th, regardless of whether the user is viewing the current data region on February 11 th or 12 th. Alternatively, a moment chosen by a system or user may be the latest value for a current data region. For example, if a user were to view a current data region of a side by side display on a particular date, but the data values are scheduled to change at a later date, the current data region may show the data values at the later date.

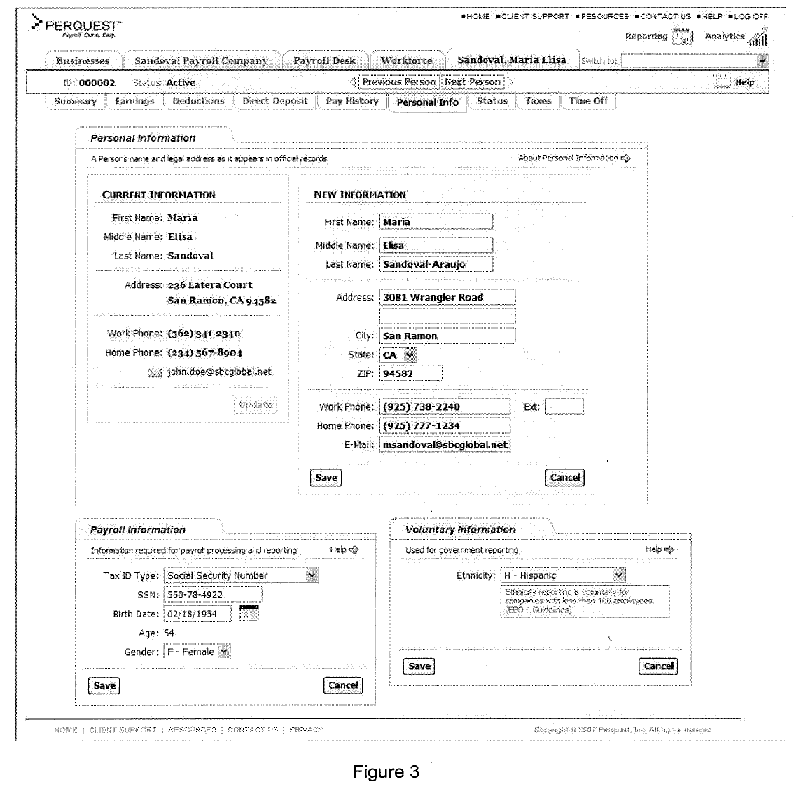

A data interaction interface may be part of a user interface that may enable a user to modify, create, or otherwise interact with data. In a preferable embodiment of the invention, such data may include payroll data or any human capital management data. FIG. 3 illustrates one embodiment of the invention where a user may interact with data interaction interfaces in a side by side display relating to payroll data. Several examples of data interaction interfaces may include a field in which a user may type in a value, a drop down menu, a button to choose an option, button to pop up another window, a link, and any other means for a user to interact with data.

A data interaction interface may enable a user to interact with a new data region. By interacting with a data interaction interface, a user may submit a new value. The new value may replace a current data value starting at a particular time. For example, if a data interaction interface in the new data region provided a field where a user could enter a user's status, the corresponding current data value in the current data region may show the user's status at the current time. The user may enter a new value for the data interaction interface which may include modifying the user's status, and the user may specify when the modification of the user's status may become effective. For instance, the modification may be effective immediately, or may come into place at a later date.

After a user may have interacted with the data interaction interface, the system may be able to store the new data values. In some instances, there may be multiple new data values relating to a particular matter. There may be multiple new data values when modifications may come into effect at different times. Going back to the previous example, a user may have a current value for the user's status, where the current value may reflect the value at the time the user is accessing the side by side display. A user's status may be scheduled to change several weeks from that date, and a new data value may be stored in the system for that change. A user may interact with the data interaction interface to schedule another change for the user's status at an even later date, and another new data value may be stored in the system for the later change. The system may be able to store all of the new data values relating to a particular matter or item along with when the new data values may come into effect.

Such storage of data values may split values into multiple time-delimited entities. For instance, as multiple new data values may be stored, the current values may be preserved up to the start date of the new values. In one embodiment of the invention, the current values need not be terminated prior to inserting new values, and may be automatically terminated when a new data value comes into effect. For example, for a particular data item, such as withholding amounts, a current value may start out as a value, suppose $1000. The current $1000 value may be in effect indefinitely. A user may enter a new data value, such as changing the withholding amount to $1500 effective February 1. The current value of $1000 may be in effect until January 31, and may terminate automatically upon that date, so that the new current value may be $1500 starting February 1. Similarly, a user may enter multiple new data values, such as changing the amount to $1200 starting March 1, and $2000 starting April 1. The values for the withholding amount may be time-delimited based on these start dates.

In one embodiment of the invention, the user may enter new data values that may be effective immediately, rather than at a later specified time, in which case the previous current data value may terminate immediately.

In another embodiment of the invention, a user may specify an end time for a data value rather than having it go on indefinitely. For example, a user may determine that a user no longer wishes to have any withholdings, and may specify a date to end that data item. In such an event, after a data item has ended, a user may have the option of creating a new record for the data item.

Data interaction interfaces of a new data region may contain default values in accordance with one embodiment of the invention. For various data interaction interfaces, default values may include some pre-entered value. For example, if a data interaction interface is a field, default values may be something typed into the field, or if a data interaction interface is a drop down menu, a default value may be a selected item on the menu, or if data interaction interfaces consists of choosing an option, an option may already be selected. If a data interaction interface does contain a default value, a user may modify the default value.

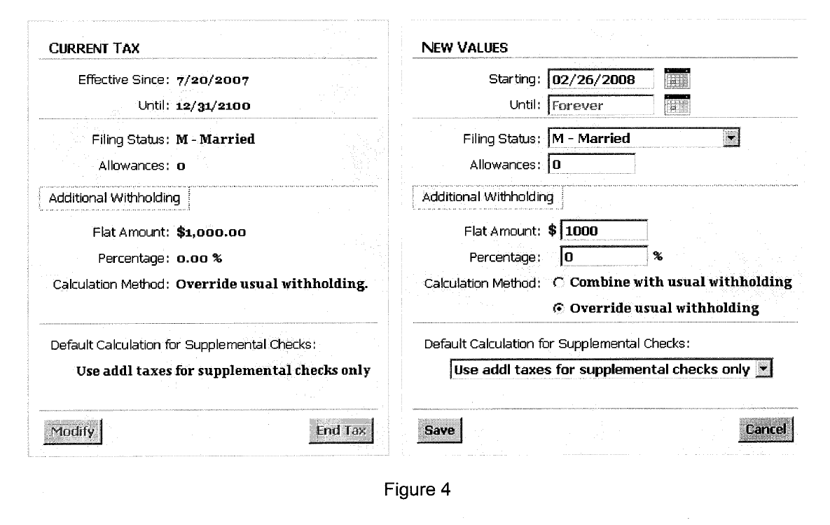

In one embodiment of the invention, the default values may be the same as the current values. FIG. 4 shows an example of a side by side display with a current data region on the left and a new data region on the right where the data interaction interfaces of the new data region contains default values. The current data of the current data region may relate to tax data. The default values for data interaction interfaces may be the same as the values for the current data region, as showed for items such as filing status, allowances, flat amount, percentage, calculation method, and default calculation for supplemental checks. Providing default values that are the same as current values may allow a user to easily modify only data that the user may wish to modify without having to enter other data values to maintain the current data values.

In another embodiment of the invention, a new data region may contain default values for data interaction interfaces that may not be the same as the values for the current data region. For instance, for a data interaction interface referring to time, a default starting time might be the current date, and a default ending time may be forever.

In an alternate embodiment of the invention, data interaction interfaces may not contain default values or default values may be blank. For example, if a data interaction interface is a field, the field may not contain any value.

In one embodiment of the invention, a new data region may contain any combination of data interaction interfaces that may contain default values that are the same as the current values, data interaction interfaces that may contain default values that are not the same as the current values, and data interaction interfaces without any default values.

A user may wish to create a new record, rather than modifying an existing record. In a preferable embodiment of the invention, when a user wishes to create a new record, the current data region may be hidden, and only a new data region may be visible. The new data region may or may not include default values that a user may or may not override.

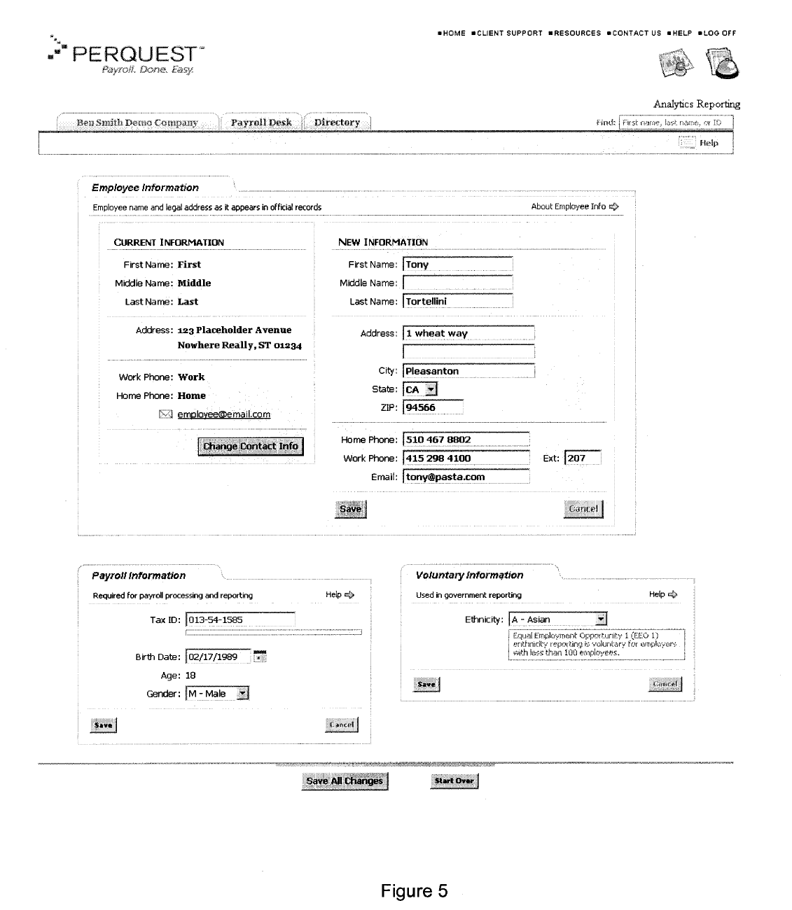

FIG. 5 shows an alternate embodiment of the invention where a user may wish to create new data, which may include a side by side display where new information may be added in a new data region. A current data region may contain current data values that are generic, and a user may interact with data interaction interfaces in a new data region to enter new data values, which may be stored in the system. For example, if a user wanted to create a new employee record, the user may enter employee information in the new data region, while the current data region may show generic values or no values.

In a preferable embodiment of the invention, the data relating to the side by side display may include human capital management data, which may include data such as payroll data (including items such as wage compensation and benefits), workforce planning, recruitment, induction/orientation, skills management, training and development, personnel administration, time management, travel management, personnel cost planning, or performance appraisal. In another embodiment of the invention, the side by side may include payroll data. Such payroll data may include data pertaining to employees, associated partners, or other pertinent parties. Payroll data may include data relating to taxes, earnings, deductions, direct deposit, personal information, time off, employee status, labor, or any other data relating to employment or payroll. Payroll data may further include more specific items such as retirement items, such as 401K, or benefits items, such as medical plan, and so forth.

The current data region and the new data region may be displayed side by side so that corresponding data may mirror or be visually mapped to one another. Mirroring may imply that data may be displayed in a particular order so that the order in the current data region may correspond to the order in the new data region. Mirroring may also imply that data may be displayed so that the corresponding nature of the data may be apparent based on the data position. For instance, this may mean that even if extra items may appear in one of the regions, the positioning or ordering may be such that corresponding data and data interaction interfaces may be apparent, even if they do not precisely match in ordering or positioning.

In a preferable embodiment of the invention, side by side may indicate that the current data region and new data region may be next to each other horizontally. For instance, the current data region may be displayed on the left while the new data region may displayed on the right. Data values within the current data region may be displayed in a vertical fashion, and data interaction interfaces and data values within the new data region may also be listed in a vertical fashion so that data interaction interfaces and data values correspond to the vertically arranged current data values. For example, if a current data region has an employee's name at the top, and the employee's status below that, and the employee's email below that, the new data region beside the current data region may have a data interaction interface for the employee's name at the top, data interaction interface for the employee's status below that, and data interaction interface for the employee's email below that.

In an alternate embodiment of the invention, side by side may indicate that the current data region and new data region may be arranged vertically, so that a current data region may be above a new data region or vice versa. Data values within the current data region may be displayed in a horizontal fashion, and data interaction interfaces and data values within the new data region may also be listed in a horizontal fashion so that data interaction interfaces and data values correspond to the horizontally arranged current data values.

In another embodiment of the invention, the current data region and the new data region may have any orientation as long as the current data values mirror or are visually mapped to some of the data interaction interfaces and data values. For example, the current data region and new data region could be diagonal one another or at any angle and could have any shape. The data values and data interaction interfaces may be disposed within the data regions in any fashion as long as the positioning of the current data values may mirror the positioning of the data interaction interfaces and new data values.

In a side by side display, the current data values of the current data region may not always precisely match the data interaction interfaces and data values of the new data region in accordance with one embodiment of the invention. In some instances, either the current data region or new data region may contain information that may or may not show up on the other data region. For example, when the data is payroll data, a current data region may show data values relating to current deductions, which may include information about the last time the deduction was taken. In corresponding new data region, data interaction interfaces may mirror the current values, but there may be no data interaction interfaces or new data for a last deduction taken. Also, the new data region may contain data interaction interfaces not relating to current data values, such as buttons to save the new data, or to cancel saving the new data.

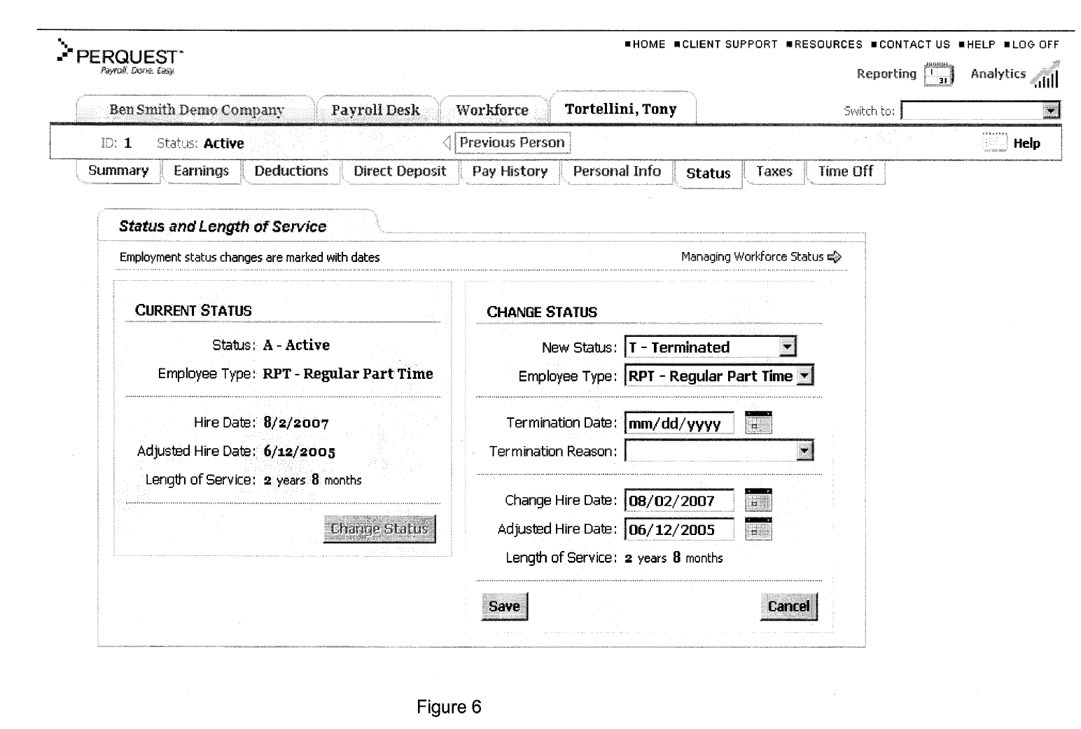

FIG. 6 shows a user interface where interacting with a new data region may cause the data interaction interfaces of the new data region to change in accordance with another embodiment of the invention. The current data values of the current data region may not always precisely match the data interaction interfaces and data values of the new data region for a side by side display. A user's interaction with a data interaction interface may cause the format of the new data region to change, while still substantially mirroring the current data region.

For example, if the side by side display was showing payroll related data, and the user were to change an employee's status to terminated, the new data region may show additional data interaction interfaces relating to the termination date and termination reason, which may not appear in the current data region. However, the other data interaction interfaces may still mirror then corresponding current data values, even if positioning may or may not be precise. The correspondence of data within the current data region and the new data region may still be apparent even if one region may have extra values or data interaction interfaces.

In some embodiments of the invention, the user interface may include various tabs. FIG. 3 shows there may be major tabs which in one embodiment of the invention may refer to information about a business, payroll data for the business, and a directory of employees within the business. FIG. 4 shows an alternate embodiment of the invention where there may be major tabs for information about a business, payroll data, directory of employees, and information about a specific employee.

There may also be smaller tabs referring to specific aspects of the information provided by the major tabs. For instance, there may be a tab for specific employee information. There may be additional tabs relating to the other minor tabs, such as tabs for payroll information of the specific employee or other information. Alternatively, there may be multiple minor tabs, such as under a specific employee, there may be smaller tabs for a summary, earnings, deductions, direct deposit, pay history, personal info, status, taxes, or time off. One of these minor tabs may be selected and may display a side a by side display corresponding to the selected tab. The user interface may also include additional navigational tools such as options to select the next employee, and so forth.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A user interface for modifying human capital management data comprising:
a side by side graphical representation having a current data region and a new data region, wherein
the current data region displays current data; and
the new data region displays one or more data interaction interfaces corresponding to the current data and positioned in a way to substantially mirror the current data position in the current data region.

2. The user interface of claim 1 wherein the current data includes payroll data.

3. The user interface of claim 1 wherein the current data includes human capital management data.

4. The user interface of claim 2 wherein payroll data includes at least one of: taxes, earnings, deductions, direct deposit, personal information, time off, status, or labor.

5. The user interface of claim 3 wherein human capital management data includes at least one of: payroll data (including items such as wage compensation and benefits), workforce planning, recruitment, induction/orientation, skills management, training and development, personnel administration, time management, travel management, personnel cost planning, or performance appraisal.

6. The user interface of claim 4 wherein deductions include 401K, CAF, GamIRS, ChSupp, miscellaneous deductions, or advances.

7. The user interface of claim 1 wherein the data interaction interfaces of the new data region have default values corresponding to the current data.

8. The user interface of claim 1 further comprising additional data interaction interfaces displayed in the new data region in response to user interaction with a data interaction interface of the new data region.

9. A graphical user interface for changing payroll information data comprising:
a first display region with a plurality of current data payroll fields; and
a second display region with a plurality of new data payroll fields, wherein the data in the current data payroll fields are visually mapped to corresponding data in the new data payroll fields.

10. The graphical user interface of claim 9, wherein the data in the current data payroll fields are visually mapped to corresponding data in the new data payroll fields in a side by side manner.

11. A graphical user interface for changing human capital management data comprising:
a first display region with a plurality of current human capital management data fields; and
a second display region with a plurality of new human capital management data fields, wherein the data in the current human capital management data fields are visually mapped to corresponding data in the new human capital management data fields.

12. The graphical user interface of claim 11, wherein the data in the current human capital management data fields are visually mapped to corresponding data in the new human capital management data fields in a side by side manner.

13. A method of modifying human capital management data comprising:
displaying a side by side graphical representation having a current data region and a new data region, wherein
the current data region displays current data; and
the new data region displays one or more data interaction interface corresponding to the current data and positioned in a way to substantially mirror the current data position in the current data region;
receiving user interaction with the data interaction interface as new data; and
storing the new data.

14. The method of claim 13 further comprising displaying new a data interaction interface within the new data region not corresponding to the current data.

15. The method of claim 13 wherein the current data includes payroll data.

16. The method of claim 13 wherein the current data includes human capital management data.

17. The method of claim 13 further comprising modifying a data interaction interface displayed in the new data region in accordance with receiving user interaction with the data interaction interface.

18. A method of changing human capital management data comprising:
displaying a first display region with a plurality of current human capital management data fields; and
displaying a second display region with a plurality of new human capital management data fields, wherein the data in the current human capital management data fields are visually mapped to corresponding data in the new human capital management data fields.

19. The method of claim 18, wherein the data in the current human capital management fields are visually mapped to corresponding data in the new human capital management data fields in a side by side manner.

20. The method of claim 18, wherein at least one of the current human capital management data fields or the new human capital management data fields includes payroll data.
